(19) United States
(12) Patent Application Publication
(10) Pub. No.: US 2011/0045736 A1
(43) Pub. Date: Feb. 24, 2011

(54) Effect Generating Device in Response to User Actions

(76) Inventor: Charles Randy Wooten, Venice, CA (US)

Correspondence Address: CHAN LAW GROUP LLP, 1055 W. 7TH ST,, SUITE 1880, LOS ANGELES, CA, 90017, US

(21) Appl. No.: 12/544,929

(22) Filed: Aug. 20, 2009

(51) Int. Cl. A63H 5/00; A63H 29/22; B23P 19/04

(52) U.S. Cl. 446/397; 446/484; 446/485; 29/428

(57) ABSTRACT

The present invention discloses a novel device having a sensing system to detect physical variance of a user, a responsive instrument to receive a signal matching the detected physical variance and correspondingly generate effect to interact with the user, and an attaching mechanism as well as an energy source to power the device. The physical variance can be the user's motion and the sensing system may include an accelerometer to detect the user's directions and accelerations.

### BACKGROUND OF THE INVENTION

This invention relates to a device, toy, and system for generating audio or visual effects in response to physical variances of a user, e.g., user motions.

Devices or toys that can provide immediate sound or lighting effects in response to human's motions appeal to children and adults. Children in particular enjoy role playing where they can emulate action heroes in movies or TV shows. Such activities often include mocking up fighting or Kung Fu playing by making noises to resemble sounds of fist swinging, striking, jabbing or getting hit by the opponent. These activities inspire kids' imagination and add up texture into their childhood.

Typical toys attempting to cater to those imaginative activities lack capacity of generating varying sound or light effects to simulate what a child would expect in direct correspondence to his or her “kung-fu” moves. The lack of animation capacity often dampens children's desire for role playing, whether in solitary or team settings. Other toys might be puffed as including those desired features to inspire children's creativity; but they nevertheless suffer from significant deficiencies.

By way of example, one type of such device, as implemented in “Star Wars®—The Force Unleashed Light saber” or described in U.S. Pat. No. 6,416,381, entitled “Motion Induced Sound And Light Generating System” (Walter, et al.), requires a user's constant control such as depressing different buttons to trigger pre-defined lighting or sound effects. Its users, by doing so, would not be able to concentrate on the plays they are engaged in as having to make additional effort to command the toy. In fact, this kind of toys is not designed to interactively respond to user's moves and therefore fails to furnish the user with true direct experience.

Other existing devices or toys, even assuming they respond to users' motions, lack a fastener or like mechanism to help spare users' hands for other activities. Some devices of this type are described in U.S. Pat. No. 6,626,728, entitled “Motion-Sequence Activated Toy Wand” (Holt) and U.S. Pat. No. 4,891,032, entitled “Flexible Toy Wand” (Davis), for example. Such devices, as being detached and loose from users' body or limbs, cannot provide users the sense of unitary whole; users thus would have to pay additional attention to avoid accidental collision with surrounding objects when swinging them.

### SUMMARY OF THE INVENTION

The present invention seeks to remedy the above noted deficiencies of the prior art by disclosing an attachable device interactive with physical variances of a user, e.g., user motions.

One embodiment of the present invention comprises a device having a sensing system to detect physical variance of the user, a responsive instrument to receive a signal matching the detected physical motion variance and correspondingly generate effect to interact with the user, and an attaching mechanism as well as an energy source to power the device.

Preferably, the sensing system comprises an accelerometer to detect motion patterns and magnitude of a user. The sensing system can further include a thermometer and/or a sphygmomanometer. A microcontroller or a digital signal processor can be used to determine based on the input detected by the foregoing measurement instruments, and a non-volatile memory can retain the determination rules and generated effect data for retrieval when processing.

In a first aspect, the inventive device includes a speaker or lighting generator to render audio or video effect, in response to a user action. The audio effect can mock up sounds that might be made by a specific move of a user, such as fist swinging, striking, colliding, blocking, or kicking. A digital to analog converter is commonly used with the speaker. The lighting generator can be a light-emitting diode.

In another aspect, the inventive device can have a band-shaped strap body with a housing within which the aforementioned parts are contained. The strap may be made of nylon or conductive material, and include an attaching mechanism, such as a fastener, including Velcro®. The device body, alternatively, can be made of pliable material, which is shaped in a way to secure itself to human body, head or limbs. This inventive device, in some embodiments, is capable of being incorporated into a watch, and other wrist-worn or ankle-worn accessories.

The energy source contained within the inventive device can be a portable-sized battery, such as solar charged battery, to supply power to the device. An on/off switch mechanism may also be added to control activation of the device generally.

These and other features and advantages of this invention will become further apparent from the detailed description and accompanying figures that follow. In the figures and description, numerals indicate the various features of the invention, and like numerals refer to like features throughout both the drawings and the description.

### BRIEF DESCRIPTION OF THE DRAWINGS

FIG. 1 is an exploded view of a sectional diagram depicting a wearable toy in accordance with the inventive device disclosed herein.

FIG. 2 is a schematic block diagram of the various components interconnected in the circuitry for a preferred embodiment of the present invention.

FIG. 3 is a flow diagram illustrating operating steps of an advantageous embodiment of the inventive device.

### DETAILED DESCRIPTION OF THE PREFERRED EMBODIMENT(S)

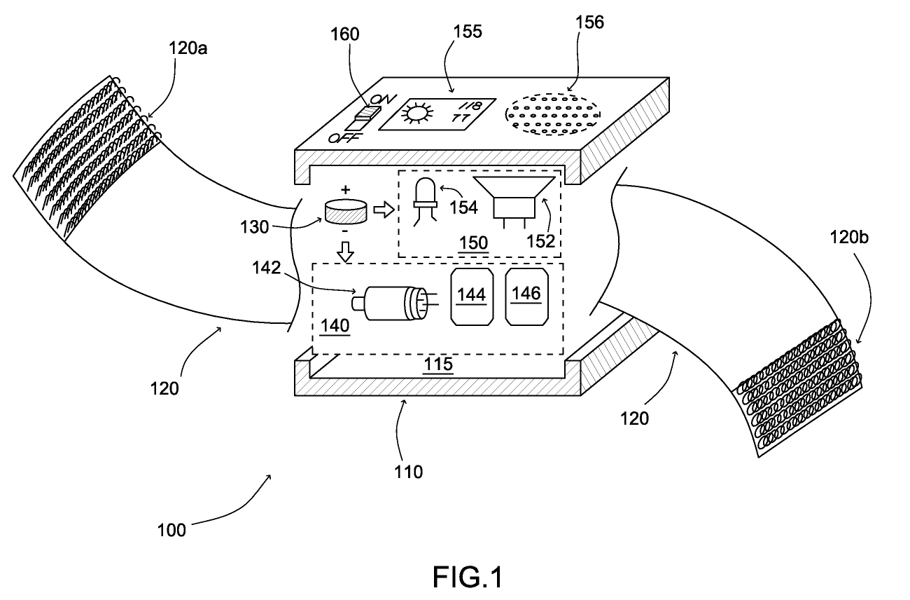

FIG. 1 is an exploded view of a sectional diagram depicting a wearable toy 100 in accordance with the inventive device disclosed herein. The wearable toy 100 is comprised of a toy body 110 and other components coupled thereto, including an attaching mechanism 120, an energy source 130, a sensing system 140, a responsive instrument 150, and an on/off switch 160. Preferably, the toy body 110 includes a housing 115 that contains these components.

The toy body 110 is preferably a band-shaped strap made of nylon, which is wrapped around a user's wrist, ankle, or head. The toy body 110 is preferably shaped to allow accommodation of other wrist- or ankle-worn devices, such as a watches, cufflink, pedometer, or other user wear, e.g., shoes and gloves. Other than nylon, the toy body 110 can also be made of materials such as polyester, fiberglass, metal, or molded plastic.

The wearable toy 100 is advantageously equipped with the attaching mechanism 120 for securing itself to the user. Such attaching mechanism 120 can be coupled to the toy body 110 on its two sides, whether removably or not. Commercial fasteners can be used as the attaching mechanism 120 such as Velcro®. As shown in FIG. 1, Velcro® hook side 120a is covered with a plurality of tiny hooks to engage numerous loops disposed upon the Velcro® loop side 120b such that the wearable toy 100 forms a circle to affix itself to the user.

According to one embodiment the toy body 110 serves as the attaching mechanism 120. Such toy body 110 is preferably made of pliable solid material(s), e.g., metal or plastic, and formed in a curved shape for gripping the user's wrist, ankle or other body parts.

The energy source 130 powers at least portions of the wearable toy 100, namely, the sensing system 140 and responsive instrument 150. The energy source can be of any suitable type such as battery, including solar charged battery, motion activated power sources, etc.

The sensing system 140 detects patterns, magnitude, and/or intensity of the user's movement. In various embodiments, the sensing system 140 also probes other physical variance of the user, such as body temperature, blood pressure, perspiration and the like. The sensing system 140 generates a signal based on the detected data and transmits the signal to the responsive instrument 150. The signal can be transmitted by any transmission method such as analog or digital, carrying the information representing the detected input as well as its magnitude or intensity.

Upon receiving the signal from the sensing system 140, the responsive instrument 150 plays audio or visual effects correspondingly. The effects generated are preferably proportional to the user input in order to create a more animated and interactive ambience to entertain the user or audience.

The sensing system 140 may include a single measurement component such as an accelerometer 142. In some embodiments it further incorporates a thermometer 144, or a sphygmomanometer/sphygmometer 146 depending on the use of the wearable toy 100. Generally, a combination of the measurement components increases the overall sensitivity to the user's physical status; and cross references from the multiple measurement components may be used to correct errors and render a more balanced result in determining the signal to match the user's motion.

The accelerometer 142 is preferably in MEMS (micro electro-mechanical systems) form and capable of detecting acceleration, direction/orientation, vibration, shock, along with magnitude. The sensed data from the thermometer 144 and/or sphygmomanometer/sphygmometer 146 can also serve as input of the sensing system 140 to determine the user's motion state. For example, steep temperature gradient and high blood pressure, being indicators of the user's elevated physical conditions, may be factored into determining the magnitude/intensity of the user's movement.

By employing input from the thermometer 144 or sphygmomanometer/sphygmometer 146 additional features can also be furnished in the wearable toy 100. For instance, the wearable toy 100 can trigger an alarm when the sensed data exceeds a certain threshold, thereby alerting the user of irregularities. The wearable toy 100 can also advantageously have a window 155 arranged on one side of the toy body 110 for showing of the readings from those measure instruments.

The responsive instrument 150 may include a loudspeaker 152, which converts the electrical signal to a sound wave form to simulate the sound of the detected motion. For example, the loudspeaker 152 can produce an audio effect like “hom” to mock up and perhaps exaggerate the sound of “striking.” Likewise, “hew” and “born” may be played by the loudspeaker 152 for the actions of “swinging” and “colliding,” respectively. The sound waves may be emitted out from the toy body 110 through the speaker apertures 156 that communicate at least a portion of the inside and outside of the housing 115.

A lighting generator 154, such as LED (Light-Emitting Diode) may also be included in the responsive instrument 150. The lighting generator 154 responds to the signal received from the sensing system 140 by outputting various lighting effects. For instance, the lighting generator 154 might project red plus yellow lights in response to a signal to exemplify the effect caused by “colliding.” The default light might be blue, for example, when no actionable signal is received by the lighting generator 154. The lighting may be transmitted from the housing 115 through e.g., the window 155. In some embodiments a window can be dispensed where the toy body 110 is made of light-transmissive materials such as plastic or nylon.

The generated effects, whether from the loudspeaker 152 or the lighting generator 154, are preferably proportional to the speed or intensity of the user's motion or physical variance. By way of example, the more swift the swinging is, the higher frequency or sound volume the loudspeaker 152 would produce.

The on/off switch 160 is a component which the user can operate to turn the wearable toy 100 on and off by controlling the power supply from the energy source 130. The types of the on/off switch 160 can be pushbutton, slide switch, or any other suitable switch that provides on and off states. Alternatively, the present invention may include a switch that is actuated by motions to spare the user the trouble of operating the switch.

When the switch 160 is actuated by the user, the sensing system 140 and responsive instrument 150 are enabled to function as described herein. In a preferred embodiment the responsive instrument 150 generates an “activation” effect to entertain the user.

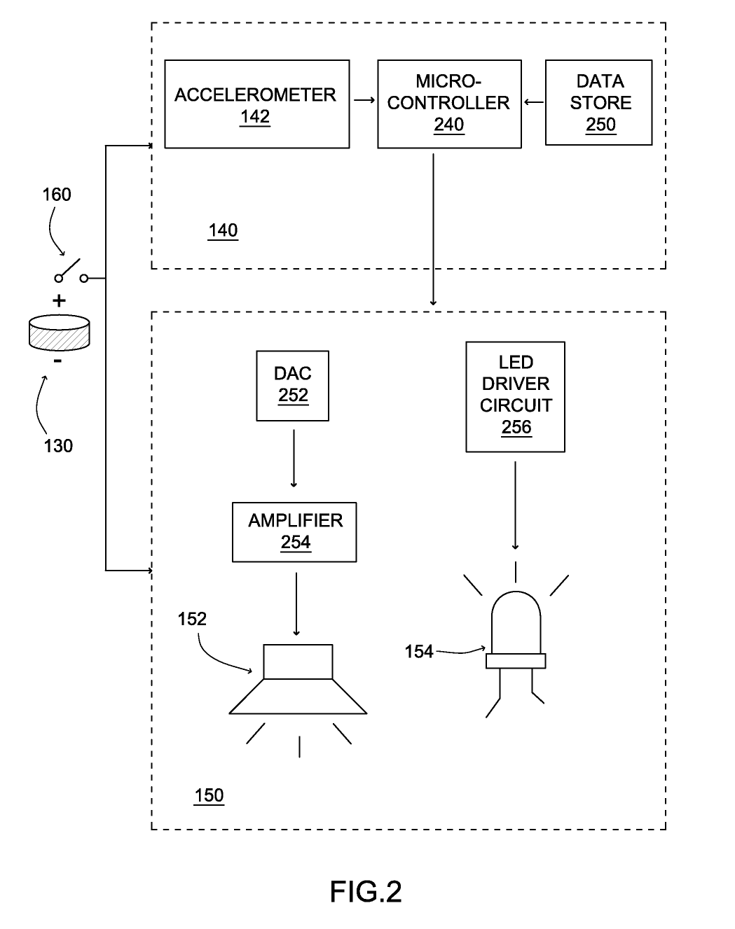

FIG. 2 is a schematic block diagram 200 of the sensing system 140, the responsive instrument 150, and their related components interconnected in the circuitry.

Both the sensing system 140 and responsive instrument can be directly or indirectly connected to the on/off switch 160 such that when the switch 160 is positioned at the “off” state, the sensing system 140 and responsive instrument 150 are disabled, and when the switch 160 is placed at the “on” state, the sensing system 140 and responsive instrument 150 are enabled and supplied with operable electrical power from the energy source 130.

The measurement instrument, such as the accelerometer 142 senses the user's physical change and translates the sensed data into electrical signals. Those electrical signals are subsequently received and analyzed by a microcontroller 240. In some embodiments the microcontroller is replaced by a microprocessor such as DSP (Digital Signal Processor). The microcontroller 240 is capable of processing the received signals and determining the associated sound or light effects to be generated. The determination rules and logics, as well as those special effects are retained in a data store 250 for retrieval by the microcontroller 240 when processing. The data store 250 is comprised of a non-volatile memory component such as ROM (read-only memory) or flash memory.

After making a determination based on the incoming electrical signals, the microcontroller 240 forwards a signal carrying the determined result to the loudspeaker 152 or the lighting generator 154 for playing effects in interaction with the user's moves. Connected between the loudspeaker 152 and the microcontroller 240 are a DAC 252 (Digital to Analog Converter) and an amplifier 254 that transform the digital signal from the microcontroller 240 to an analog one for operating the loudspeaker 152. Where an LED light is used as the lighting generator 154, a LED driver circuit 256 is required to maximize the function of the LED light.

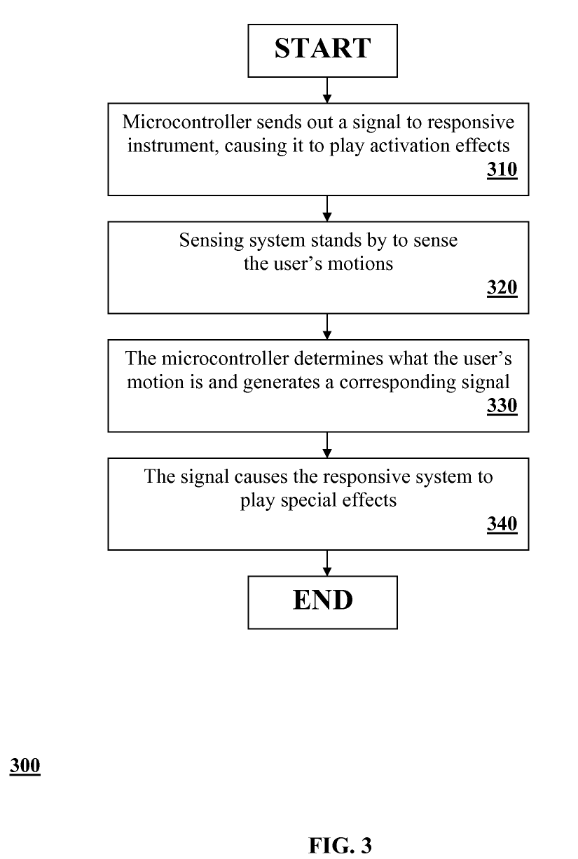

FIG. 3 is a flow diagram 300 illustrating operating steps of an embodiment of the inventive device. At start, the user turns the switch 160 on to activate the wearable toy 100. In response, the microcontroller 240 sends out a signal to the responsive instrument 150 causing it to play certain activation effects, e.g., beeping or flashing (310).

After the wearable toy 100 is activated, the sensing system 140 stands by to sense the user's motions (320). The sensed input is analyzed in the microcontroller 240 to determine the motion patterns the user is engaged in; and the microcontroller 240 generates a corresponding signal for passing on to the responsive instrument 150 (330).

The determination rules and logics employed by the microcontroller 240 vary in commercial applications. In one embodiment, the microcontroller 240 can reckon to differentiate swinging, kicking, and striking by using the direction/orientation coupled with magnitude values of the user's moving. The determination rules are so designed because each of these moves has dissimilar motion path and velocity. For example, a substantially horizontal acceleration is typical of the user waving or swinging, in response to which the microcontroller 240 generates a signal representing such move for subsequent transmission. As another example, an upward vertical acceleration is typical of the move of kicking and thus a corresponding signal is outputted. In the above two events where the detected velocity exceeds a certain threshold, striking motion can be inferred and a signal representing “striking” will be sent forth by the microcontroller 240.

On the other hand, differentiating colliding from blocking may involve use of vibration in connection with shock detections. Colliding or clashing with another object generally accompanies shock while blocking does not. Instead, one feature of blocking is vibration.

A series of input data may also be evaluated to produce a more accurate determination of the user's motions. For instance, colliding necessarily involves an adverse momentum from the collided object, regardless of whether the object is moving or stationery. Accordingly, the subsequent sensing of an adverse acceleration against the user's motion direction can distinguish colliding from other motion patterns such as striking, swinging, or kicking. Similarly, detection of shock following rapid acceleration can reinforce collision determination. The rapid acceleration can be defined as, for example, exceeding a predetermined rate of speed increase.

In various implementations, the determination rules and logics used to determine the type of the user's motions can be configurable. Additional rules may be incorporated in the sensing system 140 to discern more types of motions or to increase the accuracy of determination.

The signal reflecting the motion determination transmitted by the microcontroller 240 causes the responsive system 150 to generate intended effects (340). The played effects may cease upon receiving next signal from the microcontroller 240. Alternatively, the generated effects may last for a predetermined period of time, e.g., five seconds, and end automatically when the predetermined time expires. This can be accomplished through use of an internal clock of the microcontroller 240.

Until the user stops operating the wearable toy 100, it will reiterate the foregoing steps 320-340 in interaction with the user's movement change. If the user turns the switch 160 off, the power supply will cease, thereby deactivating the wearable toy 100.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. An attachable device interactive with physical variances of a user, the device comprising:
a device body;
an attaching mechanism disposed to secure the device body to the user;
an energy source coupled to the device body to power the device;
a sensing system coupled to the device body for detecting physical variance of the user and generating a signal in response to the detected physical variance; and
a responsive instrument coupled to the device body for receiving the signal generated by the sensing system and playing a variable effect corresponding to the signal for interacting with the user.

2. The attachable device of claim 1, wherein the physical variance includes the motion pattern of the user.

3. The attachable device of claim 1, wherein the played effect indicates at least one of the following actions of the user:
swinging;
striking;
colliding;
blocking; and
kicking.

4. The attachable device of claim 1, wherein the signal is generated in correspondence to the magnitude of the physical variance.

5. The attachable device of claim 1, wherein the sensing system includes an accelerometer to detect motion pattern of the user.

6. The attachable device of claim 1, wherein the sensing system includes a thermometer to detect temperature of the user.

7. The attachable device of claim 1, wherein the sensing system includes a sphygmomanometer or sphygmometer to detect blood pressure of the user.

8. The attachable device of claim 1, wherein the sensing system includes a microcontroller.

9. The attachable device of claim 1, wherein the sensing system includes a digital signal processor.

10. The attachable device of claim 1, wherein the sensing system includes a non-volatile memory.

11. The attachable device of claim 1, wherein the sensing system includes a digital to analog converter.

12. The attachable device of claim 1, wherein the responsive instrument includes a loudspeaker to play audio effect indicating an action sound of the user.

13. The attachable device of claim 1, wherein the responsive mechanism includes a lighting generator to play visual effect indicating a specific action of the user.

14. The attachable device of claim 13, wherein the lighting generator is a light-emitting diode.

15. The attachable device of claim 1, wherein the device body includes a housing that is coupled to user wear.

16. The attachable device of claim 1, wherein the device body includes a band-shaped strap.

17. The attachable device of claim 1, wherein the device body includes a watch.

18. The attachable device of claim 1, wherein the attaching mechanism comprises a fastener.

19. The attachable device of claim 1, wherein the attaching mechanism is integrated into the device body.

20. The attachable device of claim 1, wherein the device body is at least partially made of one or more of the following materials:
nylon,
polyester,
fiberglass,
metal, and
molded plastic.

21. The attachable device of claim 1, wherein the energy source includes a solar charged battery.

22. The attachable device of claim 1, wherein the attachable device further comprises an on/off switch to control power activation of at least the responsive instrument.

23. The attachable device of claim 22, wherein the on/off switch is actuated by the user's motion.

24. A method of manufacturing an attachable device interactive with physical variances of a user, comprising the steps of:
providing a device body;
disposing an attaching mechanism to secure the device body to the user;
coupling an energy source to the device body to power the device;
coupling a sensing system to the device body for detecting physical variance of the user and generating a signal in response to the detected physical variance; and
coupling a responsive instrument to the device body for receiving the signal generated by the sensing system and playing a variable effect corresponding to the signal for interacting with the user.
